(19) United States
(12) Patent Application Publication
(10) Pub. No.: US 2026/0039749 A1
(43) Pub. Date: Feb. 5, 2026

(54) SYSTEM AND METHOD FOR GEN AI BASED CALLING WORKFLOW OPTIMIZATION

(71) Applicant: Cognizant Technology Solutions India Pvt. Ltd., Chennai (IN)

(72) Inventors: Gargi LAHIRI, Bengaluru (IN); Saravanan RADHAKRISHNAN, Tiruvannamalai (IN); Rahul AGARWAL, Kanpur (IN); Kunal JAISWAL, Bengaluru (IN)

(21) Appl. No.: 18/905,865

(22) Filed: Oct. 3, 2024

(30) Foreign Application Priority Data
Aug. 2, 2024 (IN) 202441058598

(51) Int. Cl. H04M 3/493

(52) U.S. Cl. CPC H04M 3/493

(57) ABSTRACT

A system and method for Generative Artificial Intelligence (Gen AI) based calling workflow optimization is provided. Historic data associated with user is fetched from multiple data sources and voice commands previously provided as voice prompts over an IVR call tree by the user are fetched for generating master data sheet. Outbound call is generated in the form of Interactive Voice Response (IVR) tree for user by processing master data sheet. Responses provided over outbound call are converted to text in the form of query, via first bot type. Prompt is generated based on text in the form of query and other queries in IVR tree and generated prompt are provided as input to large language model. The large language model identifies category from master data sheet which corresponds to query based on prompt to generate reply to query. Reply to query is inserted in IVR tree in real-time.

This application claims the benefit of Indian Patent Application No. 202441058598, filed Aug. 2, 2024, which is incorporated by reference in its entirety.

### FIELD OF THE INVENTION

The present invention relates generally to the field of call management. More particularly, the present invention relates to a system and a method for Generative Artificial Intelligence (Gen AI) based calling workflow optimization.

### BACKGROUND OF THE INVENTION

Millions of calls are made yearly for customer handling using Interactive Voice Response (IVR) calling workflows. The calls may relate to customer support and services, marketing calls, Revenue Cycle Management (RCM) for healthcare, recovery calls, etc. It has been observed that 80% of the calls are outbound calls which relate to addressing key functionalities of a service, such as healthcare claims recovery, sales, inquiry, etc. Further, outbound calls, which are part of the customer service sub-process, are mainly B2B calls which are made in order to determine the status of a particular service being availed by a customer. For example, outbound calls are made to healthcare payers to check the status of the healthcare claims raised by the Provider Health Service (PHS) facilities. The call operators have to deal with multiple data sources, complex call flows and time consuming IVR traversing.

Further, it has been observed that average call time is approximately 17.5 minutes which is inclusive of IVR dial out, hold time and talk time. In addition to the average call time, call operators spend additional time answering the customer's needs and requirements. The call operators usually spend at least 7-10 minutes in After Call Work (ACW) which wastes a lot of time and resources. Also, at least ⅓^{rd} of the call cycle time spent by call operators is non-value adding which includes IVR dial out and hold time. Further, multiple calls (e.g., more than seventy call types) are made with respect to similar needs and requirements of customers (e.g., healthcare claim processing, etc.) which increases redundancy. Further, legacy hard phones (e.g., CISCO® Opex) are generally used, which are slow to operate and lead to delay in resolution of customer queries. Further, cumbersome techniques (e.g., excel based trackers, etc.) are used for creating call campaigns for work allocation for team members, which makes the overall process of IVR handling inefficient. Furthermore, conventional IVR handling techniques are associated with at least, long hold time, manual IVR dial out process, limited access to a website associated with the service and limited rendering of service status in a single call which leads to loss of efficiency. Furthermore, contact center operations are highly manual and comprise multiple and complicated IVR dialing trees for outbound dialing. Yet further, a summary report of the call is manually generated which decreases work competency.

In light of the aforementioned drawbacks, there is a need for a system and a method which provides for calling workflow optimization. There is a need for a system and a method which provides for reducing hold time and AWC time, increasing authenticity of the calls and reducing call redundancy. Further, there is a need for a system and a method which provides for efficient navigation through IVR dialling trees. Furthermore, there is a need for a system and a method which provides for eliminating or minimizing manual intervention in IVR dial out process and work allocation. Also, there is a need for a system and a method which provides for automated generation of summary report of the call process for increasing competency.

### SUMMARY OF THE INVENTION

In various embodiments of the present invention, a system for Generative Artificial Intelligence (Gen AI) based calling workflow optimization is provided. The system comprises a memory storing program instructions, a processor executing instructions stored in the memory, and a calling workflow optimization engine executed by the processor. The engine is configured to fetch historic data associated with a user from multiple data sources and one or more voice commands previously provided as one or more voice prompts over an IVR call tree by the user for generating a master data sheet. The engine is configured to generate an outbound call in the form of an Interactive Voice Response (IVR) tree for the user by processing the master data sheet. One or more user inputs provided over the outbound call are captured as responses. The engine is configured to convert the responses, via a first bot type, provided over the outbound call to text in the form of a query. Further, the engine is configured to generate a prompt based on the text in the form of the query and other queries in the IVR tree and provide the generated prompt as an input to a large language model. The large language model identifies a category from the master data sheet which corresponds to the query based on the prompt to generate a reply to the query. Lastly, the engine is configured to insert the reply to the query in the IVR tree in real-time. The engine provides for automatic traversal through the IVR tree by eliminating hold time associated with the outbound call.

In various embodiments of the present invention, a method for Generative Artificial Intelligence (Gen AI) based calling workflow optimization is provided. The method is implemented by a processor executing instructions stored in a memory. The method comprises fetching historic data associated with a user from multiple data sources and one or more voice commands previously provided as one or more voice prompts over an IVR call tree by the user for generating a master data sheet. The method comprises generating an outbound call in the form of an Interactive Voice Response (IVR) tree for the user by processing the master data sheet. One or more user inputs provided over the outbound call are captured as responses. The method comprises converting the responses, via a first bot type, provided over the outbound call to text in the form of a query. Further, the method comprises generating a prompt based on the text in the form of the query and other queries in the IVR tree and providing the generated prompt as an input to a large language model. The large language model identifies a category from the master data sheet which corresponds to the query based on the prompt to generate a reply to the query. Lastly, the method comprises inserting the reply to the query in the IVR tree in real-time. Automatic traversal through the IVR tree is provided by eliminating hold time associated with the outbound call.

In various embodiments of the present invention, a computer program product is provided. The computer program product comprises a non-transitory computer-readable medium having computer program code stored thereon, the computer-readable program code comprising instructions that, when executed by a processor, causes the processor to fetch historic data associated with a user from multiple data sources and one or more voice commands previously provided as one or more voice prompts over an IVR call tree by the user for generating a master data sheet. An outbound call is generated in the form of an Interactive Voice Response (IVR) tree for the user by processing the master data sheet. One or more user inputs provided over the outbound call are captured as responses. The responses provided over the outbound call are converted to text in the form of a query, via a first bot type. Further, a prompt is generated based on the text in the form of the query and other queries in the IVR tree and the generated prompt is provided as an input to a large language model. The large language model identifies a category from the master data sheet which corresponds to the query based on the prompt to generate a reply to the query. Lastly, the reply to the query is inserted in the IVR tree in real-time. Automatic traversal through the IVR tree is provided by eliminating hold time associated with the outbound call.

### BRIEF DESCRIPTION OF THE ACCOMPANYING DRAWINGS

The present invention is described by way of embodiments illustrated in the accompanying drawings wherein:

FIG. 1 is a detailed block diagram of a system for Gen AI based calling workflow optimization, in accordance with an embodiment of the present invention;

FIGS. 2 and 2A illustrate a flowchart depicting a method for Gen AI based calling workflow optimization, in accordance with an embodiment of the present invention; and

FIG. 3 illustrates an exemplary computer system in which various embodiments of the present invention may be implemented.

### DETAILED DESCRIPTION OF THE INVENTION

The present invention discloses a system and a method which provides for Generative Artificial Intelligence (Gen AI) based calling workflow optimization. The present invention discloses a system and a method which provides for reducing hold time and After Call Work (AWC) time, increasing authenticity of the calls and reducing call redundancy based on implementing Artificial Intelligence (AI) and Machine Learning (ML) techniques. The present invention discloses a system and a method which provides for efficient traversal through IVR dialling trees by using Generative AI (Gen AI) techniques. Further, the present invention discloses a system and a method which provides for eliminating or minimizing manual intervention in IVR dial out process and work allocation. Furthermore, the present invention discloses a system and a method which provides for automating generation of summary report of the call process for increasing competency.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

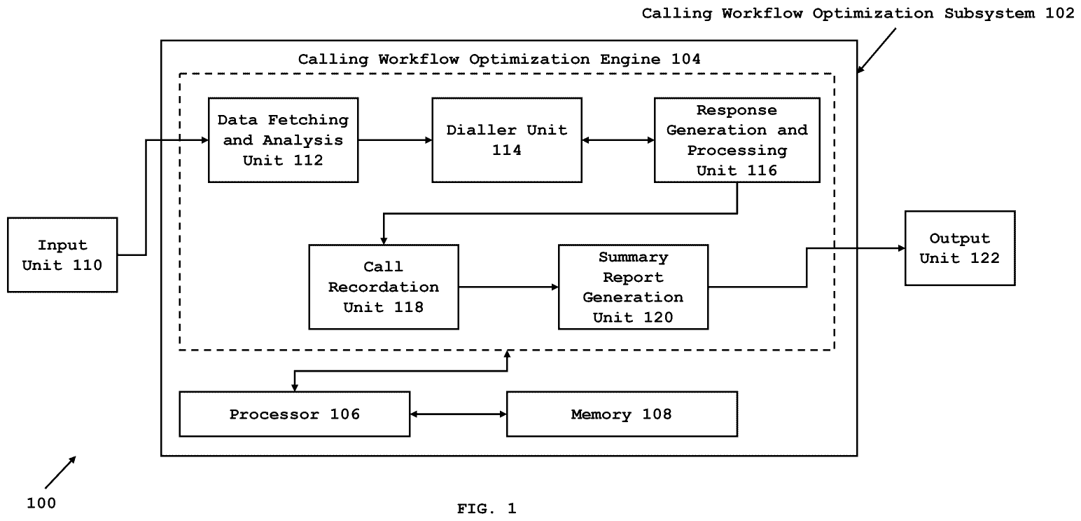

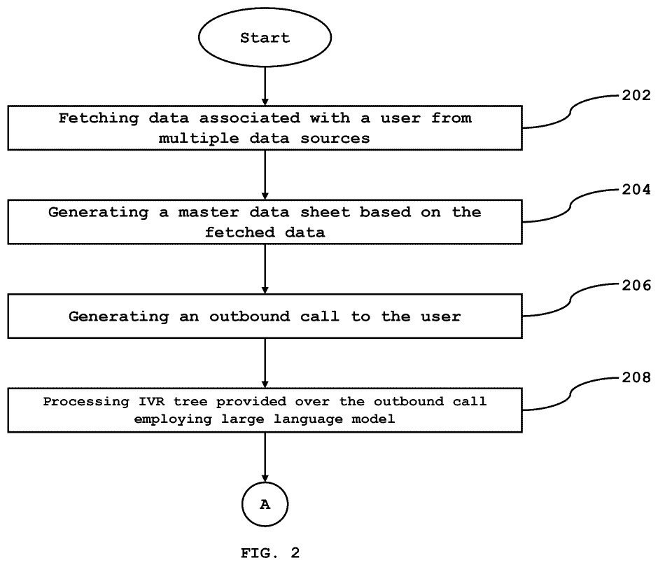

FIG. 1 is a detailed block diagram of a system 100 for Gen AI based calling workflow optimization, in accordance with various embodiments of the present invention. Referring to FIG. 1, in an embodiment of the present invention, the system 100 comprises a calling workflow optimization subsystem 102, an input unit 110, and an output unit 122. In an exemplary embodiment of the present invention, the input unit 110 and the output unit 122 may be a user device which may include electronic devices associated with a user (a caller or a calling agent) such as, but not limited to, a smartphone, a mobile phone, a computer and a laptop. The input unit 110 and the output unit 124 are connected to the subsystem 102 via a communication channel (not shown). The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a local area network (LAN), a metropolitan area network (MAN) and a wide area network (WAN).

In an embodiment of the present invention, the subsystem 102 is configured with a built-in mechanism for optimizing IVR calling workflow. The subsystem 102 implements AI/ML techniques and Gen AI techniques for optimizing IVR calling workflow. Continuous learning and training of the subsystem 102 is carried out for optimizing the IVR calling workflow. The subsystem 102 is configured with an intelligent dialler which executes automated functionalities including, but not limited to, automatically dialling outbound calls, traversing through IVR trees, authenticating a call, holding a call, connecting calls to available call handling agent upon successful connection to a human voice and transcribing the call details after call ends. Further, the subsystem 102 operates in an agentless mode for fetching data from IVR voice segments.

In an embodiment of the present invention, the subsystem 102 comprises a calling workflow optimization engine 104 (engine 104), a processor 106, and a memory 108. In various embodiments of the present invention, the engine 104 has multiple units which work in conjunction with each other for Gen AI based calling workflow optimization. The various units of the engine 104 are operated via the processor 106 specifically programmed to execute instructions stored in the memory 108 for executing respective functionalities of the units of the engine 104 in accordance with various embodiments of the present invention.

In another embodiment of the present invention, the subsystem 102 may be implemented in a cloud computing architecture in which data, applications, services, and other resources are stored and delivered through shared datacenters. In an exemplary embodiment of the present invention, the functionalities of the subsystem 102 are delivered to a user as Software as a Service (SaaS) over a communication network.

In another embodiment of the present invention, the subsystem 102 may be implemented as a client-server architecture or in an application-based environment. In this embodiment of the present invention, a client terminal accesses a server hosting the subsystem 102 over a communication network. The client terminals may include but are not limited to a smart phone, a computer, a tablet, microcomputer or any other wired or wireless terminal. The server may be a centralized or a decentralized server.

In an embodiment of the present invention, the engine 104 comprises a data fetching and analysis unit 112, a dialler unit 114, a response generation and processing unit 116, a call recordation unit 118, and a summary report generation unit 120.

In operation, in an embodiment of the present invention, the data fetching and analysis unit 112 is configured to automatically fetch historic data associated with a user from multiple data sources via the input unit 110 by using an Application Programing Interface (API). The data sources include, but are not limited to, client databases (such as, central repository storing healthcare policy information), excel trackers related to logs for tracking recent client interactions, policy documents or other documents related to source for specific data such as, policy numbers and health issue treatment data, client websites for acquiring contact center data, including call numbers and hierarchical call routing data. The user may be a caller availing a particular service associated with a domain (e.g., an insured person availing an insurance, a patient availing healthcare benefit, etc.). The data sources may be located at a remote location or may be located on the premises. The fetched data is provided as an input to the data fetching and analysis unit 112 via the input unit 110. The fetched data may include, but are not limited to, caller's personal details, service details availed by the caller, past inputs and queries provided by the caller, input list used in the IVR by the caller, policy data fetched from client database (relating to coverage, terms, and client history), last call data maintained by the team to understand client interactions from excel trackers, policy numbers and health issue treatment data from policy documents or relevant unstructured documents, contact center data (including call numbers and IVR call tree data) to facilitate efficient communication from client websites. The data fetching and analysis unit 112 is configured to analyze and clean the fetched data. In another embodiment of the present invention, the data fetching and analysis unit 112 is configured to fetch one or more voice commands previously provided as one or more voice prompts over the IVR call tree by the user with respect to the service availed. For example, a user may mention an insurance number associated with an insurance policy, a caller may say ‘Yes’ or ‘No’ while answering a question provided over the IVR, etc. In an embodiment of the present invention, the data fetching and analysis unit 112 is configured to generate a master data sheet by using the fetched data and the fetched one or more voice prompts. The master data sheet is automatically generated and comprises all the fetched data associated with the user and voice prompts, which is parsed in a column format. The master data sheet is generated by using one or more minibots including, but are not limited to, MS Excel VBA® and Macros®.

In an embodiment of the present invention, the dialler unit 114 is configured to receive the generated master data sheet comprising the fetched data and the voice prompts from the data fetching and analysis unit 112. The dialler unit 114 is configured to automatically generate an outbound call to the user with respect to the services availed by the user by processing the master data sheet. The dialler unit 114 is configured to implement one or more automatic dialing techniques including, but are not limited to, a preview dialing technique, a predictive dialing technique, a progressive dialing technique, and an agent controlled dialing technique for automatically generating the outbound calls to the user. The dialler unit 114 generates an IVR tree and provides the IVR over the outbound call to the user via the input unit 110 based on the processed master data sheet. The user provides a response to an option provided via the IVR. The response may include, but is not limited to, a Dual Tone Multi-Frequency (DTMF) input or an acoustic input (e.g., a speech command, a voice prompt, etc.). In an example, based on the IVR, the user may provide the DTMF input by pressing key no. 9 on a keypad of the input unit 110 for receiving information with respect to healthcare claims. In another example, based on the IVR, the user provides the acoustic input by mentioning the insurance number associated with an insurance policy for receiving the required information. The responses received from the user are processed by the dialler unit 114.

In an embodiment of the present invention, the response generation and processing unit 116 receives the response from the dialler unit 114 and implements a first bot type for processing the received response. The first bot type employs Natural Language Understanding (NLU) techniques and Large Language Models (LLMs). In an exemplary embodiment of the present invention, the LLM employed may be Azure® Open AI, which is a Gen AI based technique. In an embodiment of the present invention, the response generation and processing unit 116 implements the first bot to convert the received response to text in the form of a query. In particular, the response generation and processing unit 116 implements the first bot type by communicating with an LLM via an API to provide a reply to the query. A prompt is generated based on the text in the form of the query and other queries in the IVR tree and provided as an input to the LLM for generating a reply to the query. The LLM analyzes the context of the prompt and identifies a category from the master data sheet which corresponds to the prompt to obtain a reply to a query. The response generation and processing unit 116 inserts the reply to the query in real-time to the IVR tree, therefore, eliminating the time taken by the user to respond. In an embodiment of the present invention, the replies to the queries are tracked and if incorrect replies are determined to be generated by the LLM, then fine tuning of the LLM is carried out for providing correct replies. For example, if a query relates to determining healthcare claims payment data by a payer, then the response generation and processing unit 116 generates a prompt based on the query and the LLM identifies the category i.e., ‘amount associated with the healthcare claims payment data’ present in the master data sheet for obtaining the reply to the query. The response generation and processing unit 116 is configured to maintain a performance log of replies to the query. Advantageously, the system 100 provides for automatic traversal through the IVR tree which aids in eliminating hold time associated with a call.

In an embodiment of the present invention, the call recordation unit 118 is configured to receive the reply to the query provided in the IVR tree for transferring the call to a call agent. The call is transferred to the call agent based on human energy detection during the call. Further, the agent analyzes the master data sheet and the IVR including the reply to the query associated with the user on a User Interface (UI) at his/her end. The call agent may provide a solution to the user for his/her query. In an embodiment of the present invention, the call recordation unit 118 is configured to record the call between the call agent and the user for continuous learning and improvement.

In an embodiment of the present invention, the summary report generation unit 120 is configured to automatically generate a summary report of the call between the call agent and the user based on the recorded call received from the call recordation unit 118. Firstly, the summary report generation unit 120 is configured to convert the recorded call to a text format by using an Automated Speech Recognition (ASR) technique. Secondly, the summary report generation unit 120 is configured to carry out cleaning of any unnecessary data present in the converted text and further correct any misspelt words in the text by using a Natural Language Processing (NLP) technique. In an embodiment of the present invention, the summary report generation unit 120 is configured to implement a second bot type for generating the summary report by parsing one or more essential parameters of the call between the call agent and the user, present in the converted text. The essential parameters include, but are not limited to, user data (e.g., name of the user, policy number of the user, etc.), inquiry data (e.g., type of inquiry, specific questions such as coverage data, making claim, etc.), service domain data (e.g., healthcare claim data, date of incident, status, etc.), and response data associated with the IVR call tree (e.g., agent response, resolution status, etc.). The second bot type employs Natural Language Understanding (NLU) technique and the LLMs for generating the summary report. In an exemplary embodiment of the present invention, LLMs are used to generate contextual embeddings that capture meaning and context of conversation. Further, intent behind each segment of the conversation is identified by the summary report generation unit 120, such as a query, complaint, or request for information. Lastly, a concise summary is generated using the LLMs that includes paraphrased essential data of the call between the call agent and the user. In an embodiment of the present invention, the generated summary report is rendered on the output unit 122 via a Graphical User Interface (GUI). Advantageously, automated generation of summary report saves time, reduces human intervention and provides error free data compilation.

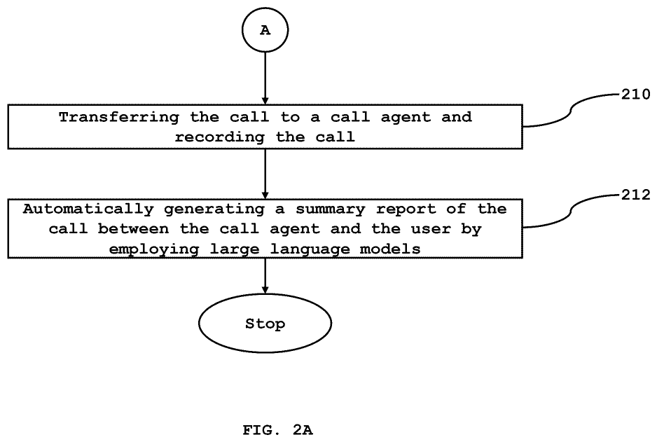

FIG. 2 and FIG. 2A illustrate a flowchart depicting a method for Gen AI based calling workflow optimization, in accordance with an embodiment of the present invention.

At step 202, data associated with a user is automatically fetched from multiple data sources. In an embodiment of the present invention, historic data associated with a user is automatically fetched by the input unit 110 from multiple data sources via an Application Programing Interface (API). The data sources may include, but are not limited to, client databases (such as, central repository storing healthcare policy information), excel trackers related to logs for tracking recent client interactions, policy documents or other documents related to source for specific data such as, policy numbers and health issue treatment data, client websites for acquiring contact center data, including call numbers and hierarchical call routing data. The user may be a caller availing a particular service associated with a domain (e.g., an insured person availing an insurance, a patient availing healthcare benefits, etc.). The fetched data is provided as an input and includes, but is not limited to, caller's personal details, service details availed by the caller, past inputs and queries provided by the caller, input list used in the IVR by the caller, policy data fetched from client database (relating to coverage, terms, and client history), last call data maintained by the team to understand client interactions from excel trackers, policy numbers and health issue treatment data from policy documents or relevant unstructured documents, contact center data (including call numbers and IVR call tree data) to facilitate efficient communication from client websites.

At step 204, a master data sheet is generated based on the fetched data. In an embodiment of the present invention, the fetched data is analyzed and cleaned. In another embodiment of the present invention, one or more voice commands previously provided as one or more voice prompts over the IVR call tree by the user with respect to the service availed are fetched. For example, a user may mention an insurance number associated with an insurance policy, a caller may say ‘Yes’ or ‘No’ while answering a question provided over the IVR, etc. In an embodiment of the present invention, the data fetching and analysis unit 112 is configured to generate a master data sheet by using the fetched data and the fetched one or more voice prompts. The master data sheet is automatically generated and comprises all the fetched data associated with the user and voice prompts, which is parsed in a column format. The master data sheet is generated by using one or more minibots including, but are not limited to, MS Excel VBA® and Macros®.

At step 206, an outbound call to the user is generated. In an embodiment of the present invention, the outbound call is automatically initiated with respect to the services availed by the user by processing the master data sheet comprising the fetched data and the voice prompts. One or more automatic dialing techniques including, but are not limited to, a preview dialing technique, a predictive dialing technique, a progressive dialing technique, and an agent controlled dialing technique are implemented for automatically initiating the outbound calls to the user. An IVR tree is generated and provided to the user over the outbound call based on the processed master data sheet. The user provides a response to an option provided via the IVR. The response may include, but is not limited to, a Dual Tone Multi-Frequency (DTMF) input or an acoustic input (e.g., a speech command, a voice prompt, etc.). In an example, based on the provided IVR tree, the user may provide the DTMF input by pressing key no. 9 on a keypad for getting information with respect to healthcare claims. In another example, based on the IVR, the user provides the acoustic input by mentioning the insurance number associated with an insurance policy for receiving the required information. The required responses are received from the user and processed.

At step 208, the IVR tree provided over the outbound call is processed by employing large language models. In an embodiment of the present invention, a first bot type is implemented for processing the response. The first bot type employs Natural Language Understanding (NLU) techniques and Large Language Models (LLMs). In an exemplary embodiment of the present invention, the LLMs employed may be Azure® Open AI, which is a Gen AI based technique. The first bot converts the response to text in the form of a query. In particular, the first bot type is implemented by communicating with an LLM via an API to provide a reply to the query. A prompt is generated based on the text in the form of the query and other queries in the IVR tree and provided as an input to the LLM for generating a reply to the query. The LLM analyzes the context of the prompt and identifies a category from the master data sheet which corresponds to the prompt to obtain a reply to a query. The reply to the query is inserted in real-time to the IVR tree, therefore, eliminating the time taken by the user to respond. In an embodiment of the present invention, the replies to the queries are tracked and if incorrect replies are determined to be generated by the LLM, then fine tuning of the LLM is carried out for providing correct replies. For example, if a query relates to determining healthcare claims payment data by a payer, then a prompt is generated based on the query and the LLM identifies the category i.e., ‘amount associated with the healthcare claims payment data’ present in the master data sheet for obtaining the reply to the query. A performance log of the queries and replies to the queries is maintained.

At step 210, the call is transferred to a call agent and is recorded. In an embodiment of the present invention, the call is transferred to the call agent based on human energy detection during the call. Further, the agent analyzes the master data sheet and the IVR including the reply to the query associated with the user via a User Interface (UI) at his/her end. The call agent may provide a solution to the user for his/her query. In an embodiment of the present invention, the call between the call agent and the user is recorded for continuous learning and improvement.

At step 212, a summary report of the call between the call agent and the user is automatically generated by employing large language models. In an embodiment of the present invention, the summary report is automatically generated based on the recorded call. Firstly, the recorded call is converted to a text format by using an Automated Speech Recognition (ASR) technique. Secondly, cleaning of any unnecessary data present in the converted text is carried out and further correction of any misspelt words in the text is carried out by using a Natural Language Processing (NLP) technique. In an embodiment of the present invention, a second bot type is implemented for generating the summary report by parsing one or more essential parameters of the call between the call agent and the user, present in the converted text. The essential parameters include, but are not limited to, user data (e.g., name of the user, policy number of the user, etc.), inquiry data (e.g., type of inquiry, specific questions such as coverage data, making claim, etc.), service domain data (e.g., healthcare claim data, date of incident, status, etc.), and response data associated with the IVR call tree (e.g., agent response, resolution status, etc.). The second bot type employs Natural Language Understanding (NLU) technique and Large Language Models (LLMs) such as, ChatGPT®, etc. for generating the summary report. In an exemplary embodiment of the present invention, LLMs are used to generate contextual embeddings that capture meaning and context of conversation. Further, intent behind each segment of the conversation is identified such as a query, complaint, or request for information. Lastly, a concise summary is generated using the LLMs that includes paraphrased essential data of the call between the call agent and the user. In an embodiment of the present invention, the generated summary report is rendered via a Graphical User Interface (GUI).

Advantageously, in accordance with various embodiments of the present invention, Gen AI based calling workflow optimization and automation is provided. The present invention provides for reducing hold time and AWC time, increasing authenticity of the calls and reducing call redundancy. The present invention provides for automated traversal through IVR dialling trees by using Gen AI techniques. The present invention provides for effectively capturing and processing the context and meaning of the user input over an IVR tree by leveraging learning capabilities of Gen AI techniques. Further, the present invention provides for answering new user queries during the training phase based on learnings obtained through use of Gen AI techniques. Further, the present invention provides for eliminating or minimizing manual intervention in IVR dial out process and work allocation, thereby increasing efficiency. Yet further, the present invention provides for faster call processing thereby accelerating decision-making and improving operational efficiency. Also, the present invention provides for saving costs in call workflows by reducing manual intervention and error rates.

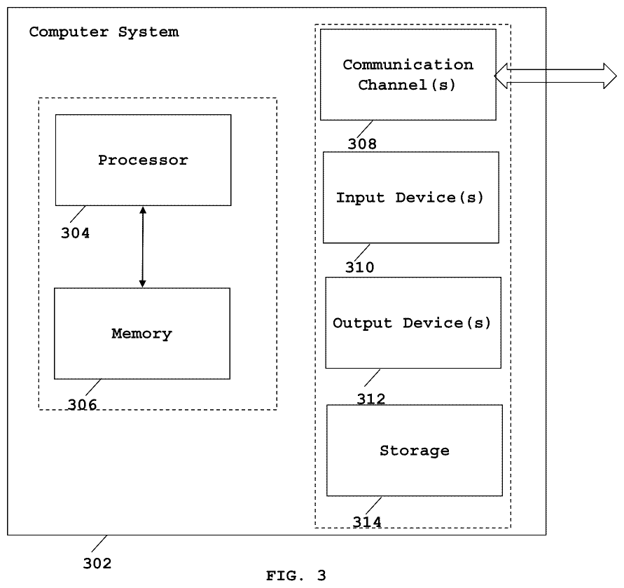

FIG. 3 illustrates an exemplary computer system 302 in which various embodiments of the present invention may be implemented. The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302 and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth, or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including, but not limited to microwave, infrared, Bluetooth, or other transmission techniques. These instructions can be preloaded into a system or recorded on a storage medium such as a CD-ROM or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for Generative Artificial Intelligence (Gen AI) based calling workflow optimization, the system comprises:
a memory storing program instructions;
a processor executing instructions stored in the memory; and
a calling workflow optimization engine executed by the processor and configured to:
fetch historic data associated with a user from multiple data sources and one or more voice commands previously provided as one or more voice prompts over an IVR call tree by the user for generating a master data sheet;
generate an outbound call in the form of an Interactive Voice Response (IVR) tree for the user by processing the master data sheet, wherein one or more user inputs provided over the outbound call are captured as responses;
convert the responses, via a first bot type, provided over the outbound call to text in the form of a query;
generate a prompt based on the text in the form of the query and other queries in the IVR tree and provide the generated prompt as an input to a large language model, wherein the large language model identifies a category from the master data sheet which corresponds to the query based on the prompt to generate a reply to the query; and
insert the reply to the query in the IVR tree in real-time, wherein the calling workflow optimization engine provides for automatic traversal through the IVR tree by eliminating hold time associated with the outbound call.

2. The system as claimed in claim 1, wherein the calling workflow optimization engine transfers the outbound call to a call agent after the reply to the query is inserted in the IVR tree, wherein one or more essential parameters of the call between the call agent and the user are parsed, via a second bot type, for generating a summary report.

3. The system as claimed in claim 1, wherein the calling workflow optimization engine comprises a dialler unit executed by the processor and configured to automatically generate the outbound call to the user with respect to services availed by the user by processing the master data sheet and transfer the outbound call to the user based on one or more automatic dialing techniques comprising a preview dialing technique, a predictive dialing technique, a progressive dialing technique, and an agent controlled dialing technique.

4. The system as claimed in claim 3, wherein the dialler unit is configured to transfer the generated IVR tree over the outbound call to an input unit, and wherein the captured responses correspond to a Dual Tone Multi-Frequency (DTMF) input, or an acoustic input provided in response to an option provided via the IVR tree.

5. The system as claimed in claim 1, wherein the calling workflow optimization engine comprises a response generation and processing unit executed by the processor configured to implement the first bot type for processing the received responses, and wherein the large language model analyzes context of the prompt and identifies the category from the master data sheet which corresponds to the prompt to obtain the reply to the query.

6. The system as claimed in claim 5, wherein the response generation and processing unit is configured to maintain a performance log of queries and replies to the queries.

7. The system as claimed in claim 2, wherein the calling workflow optimization engine comprises a call recordation unit executed by the processor and configured to transfer the call to the call agent based on a determination of the inserted reply to the query in the IVR tree.

8. The system as claimed in claim 2, wherein the calling workflow optimization engine comprises a summary report generation unit executed by the processor and configured to automatically generate the summary report of the call between the call agent and the user based on a recorded call received from the call recordation unit.

9. The system as claimed in claim 8, wherein the summary report generation unit is configured to implement the second bot type by converting the recorded call to a text format by using an Automated Speech Recognition (ASR) technique, and wherein the summary report generation unit is configured to carry out cleaning of unnecessary data present in the converted text and correction of misspelt words in the text by using a Natural Language Processing (NLP) technique, and wherein the second bot type employs Natural Language Understanding (NLU) technique and Large Language Models for generating the summary report which is rendered on an output unit via a Graphical User Interface (GUI).

10. The system as claimed in claim 2, wherein the essential parameters comprise user data, inquiry data, service domain data, and response data associated with the IVR call tree.

11. The system as claimed in claim 1, wherein the multiple data sources include client databases, excel trackers related to logs for tracking recent client interactions, policy document sources, client websites for acquiring contact center data including call numbers and hierarchical call routing data.

12. A method for Generative Artificial Intelligence (Gen AI) based calling workflow optimization, the method is implemented by a processor executing instructions stored in a memory, the method comprises:
fetching historic data associated with a user from multiple data sources and one or more voice commands previously provided as one or more voice prompts over an IVR call tree by the user for generating a master data sheet;
generating an outbound call in the form of an Interactive Voice Response (IVR) tree for the user by processing the master data sheet, wherein one or more user inputs provided over the outbound call are captured as responses;
converting the responses, via a first bot type, provided over the outbound call to text in the form of a query;
generating a prompt based on the text in the form of the query and other queries in the IVR tree and providing the generated prompt as an input to a large language model, wherein the large language model identifies a category from the master data sheet which corresponds to the query based on the prompt to generate a reply to the query; and
inserting the reply to the query in the IVR tree in real-time, wherein automatic traversal through the IVR tree is provided by eliminating hold time associated with the outbound call.

13. The method as claimed in claim 12, wherein the outbound call is automatically generated with respect to services availed by the user by processing the master data sheet and the outbound call is transferred to the user based on one or more automatic dialing techniques comprising a preview dialing technique, a predictive dialing technique, a progressive dialing technique, and an agent controlled dialing technique.

14. The method as claimed in claim 12, wherein the first bot type is implemented for processing the received responses, and wherein the large language model analyzes context of the prompt and identifies the category from the master data sheet which corresponds to the prompt to obtain the reply to the query.

15. The method as claimed in claim 12, wherein the outbound call is transferred to a call agent after the reply to the query is inserted in the IVR tree, wherein one or more essential parameters of the call between the call agent and the user are parsed, via a second bot type, for generating a summary report.

16. The method as claimed in claim 15, wherein the summary report of the call between the call agent and the user is automatically generated based on a recorded call.

17. The method as claimed in claim 16, wherein a second bot type is implemented by converting the recorded call to a text format by using an Automated Speech Recognition (ASR) technique, and wherein cleaning of unnecessary data present in the converted text is carried out and misspelt words are corrected in the text by using a Natural Language Processing (NLP) technique, and wherein the second bot type employs Natural Language Understanding (NLU) technique and Large Language Models for generating the summary report via a Graphical User Interface (GUI).

18. A computer program product comprising:
a non-transitory computer-readable medium having computer program code stored thereon, the computer-readable program code comprising instructions that, when executed by a processor, causes the processor to:
fetch historic data associated with a user from multiple data sources and one or more voice commands previously provided as one or more voice prompts over an IVR call tree by the user for generating a master data sheet;
generate an outbound call in the form of an Interactive Voice Response (IVR) tree for the user by processing the master data sheet, wherein one or more user inputs provided over the outbound call are captured as responses;
convert the responses, via a first bot type, provided over the outbound call to text in the form of a query;
generate a prompt based on the text in the form of the query and other queries in the IVR tree and providing the generated prompt as an input to a large language model, wherein the large language model identifies a category from the master data sheet which corresponds to the query based on the prompt to generate a reply to the query; and
insert the reply to the query in the IVR tree in real-time, wherein automatic traversal through the IVR tree is provided by eliminating hold time associated with the outbound call.
